(19) United States
(12) Patent Application Publication
(10) Pub. No.: US 2022/0284757 A1
(43) Pub. Date: Sep. 8, 2022

(54) SLOT TYPE GAMES WITH DYNAMIC PAYLINES AND DYNAMIC PAYLINE MODIFIERS

(71) Applicant: Aristocrat Technologies, Inc., Las Vegas, NV (US)

(72) Inventors: Daniel Marks, Decatur, GA (US); Hua Xu, Marietta, GA (US); David Marsh, Charlottesville, VA (US); Karl Roelofs, Charlottesville, VA (US); William Lamb, Eagleville, TN (US)

(21) Appl. No.: 17/490,020

(22) Filed: Sep. 30, 2021

Related U.S. Application Data
(60) Provisional application No. 63/156,805, filed on Mar. 4, 2021.

(51) Int. Cl. G07F 17/32; G06Q 50/34

(52) U.S. Cl. CPC G07F 17/326; G07F 17/3225; G06Q 50/34

(57) ABSTRACT

A slot type game with one or more dynamic paylines and/or dynamic payline modifiers includes a grid or matrix of symbols for which one or more symbol outcomes may be determined and presented. In embodiments with a dynamic payline, the slot type game also includes a payline determination for which a payline outcome may be determined and presented. The payline outcome may correspond to positions of symbols in the grid or matrix and may determine whether or not the corresponding symbols in the grid or matrix are winners. In embodiments with a dynamic payline modifier, the slot type game also includes a payline modifier for which a payline modifier outcome may be determined and presented. The payline modifier outcome may correspond to positions of symbols in one or more paylines and may determine whether or not the one or more paylines and/or symbols are modified.

### CROSS-REFERENCE TO RELATED APPLICATION

This application is a nonprovisional of, and claims the benefit under 35 U.S.C. § 119(e) of, U.S. Provisional Patent Application No. 63/156,805, filed Mar. 4, 2021, the contents of which are incorporated herein by reference as if fully disclosed herein.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Some typical games, such as Class III slot type games, use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Other typical games, such as Class II slot type games, determine a result of a bingo game and then select and present a slot type game outcome that corresponds to the result of the bingo game (such as one or more “facades” or slot type game screens that have an outcome matching that of the result of the bingo game). Notably, some games may include an element of skill on the part of the player and are therefore not entirely random.

### SUMMARY

In various examples, a system for providing and/or operating a slot type game with a dynamic payline determines a symbol reel outcome for multiple reels, each reel comprising multiple symbols and the symbol reel outcome comprising multiple symbols displayed at multiple display positions; presents the symbol reel outcome; determines a payline determination outcome for at least one payline determination indicator; presents the payline determination outcome, and determines an award amount based on the multiple symbols in the multiple display positions corresponding to the payline determination outcome.

In some examples, a system for providing and/or operating a slot type game with a dynamic payline includes at least one symbol reel operable to iterate through a sequence of possible symbol reel outcomes and stop at a final symbol reel outcome. The system also includes at least one payline determination indicator operable to iterate through a sequence of possible payline determination outcomes and stop at a final payline determination outcome. The system further includes at least one processor that determines a game outcome according to the final symbol reel outcome and the final payline determination outcome.

In a number of examples, a system for providing and/or operating a slot type game with a dynamic payline modifier determines a symbol reel outcome of multiple reels, each reel comprising multiple symbols and the symbol reel outcome comprising multiple symbols displayed at multiple display positions; presents the symbol reel outcome; determines a payline modifier outcome; presents the payline modifier outcome; and determines an award amount corresponding to the symbol reel outcome, at least one payline, and a relationship between the at least one payline and the payline modifier outcome.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a flow chart illustrating a method for providing and/or operating a slot type game with a dynamic payline. The method may be performed by and/or using one or more of the gaming devices and/or the gaming data center of FIGS. 1-2C and/or using the game processing architecture of FIG. 3.

FIG. 5A depicts a first example slot type game with a dynamic payline. This first example slot type game may be provided by the method of FIG. 4.

FIG. 5B depicts the first example slot type game of FIG. 5A after the outcome of a dynamic payline determination is presented.

FIG. 5C depicts a subsequent play of the first example slot type game of FIG. 5B where an outcome of a subsequent dynamic payline is determined and presented.

FIG. 6A depicts a second example slot type game with a dynamic payline. This second example slot type game may be provided by the method of FIG. 4.

FIG. 6B depicts the first example slot type game of FIG. 6A after the outcome of the dynamic payline is determined and presented.

FIG. 6C depicts a subsequent play of the first example slot type game of FIG. 6B where an outcome of a dynamic payline determination is presented.

FIG. 7A depicts a third example slot type game with a dynamic payline. This third example slot type game may be provided by the method of FIG. 4.

FIG. 7B depicts the first example slot type game of FIG. 7A after the outcome of the dynamic payline is determined and presented.

FIG. 7C depicts a subsequent play of the first example slot type game of FIG. 7B where an outcome of a dynamic payline determination is presented.

FIG. 8A depicts a first output of a fourth example slot type game with a dynamic payline. This fourth example slot type game may be provided by the method of FIG. 4.

FIG. 8B depicts a second output of the fourth example slot type game of FIG. 8A.

FIG. 8C depicts a third output of the fourth example slot type game of FIG. 8A.

FIG. 8D depicts a fourth output of the fourth example slot type game of FIG. 8A.

FIG. 8E depicts a fifth output of the fourth example slot type game of FIG. 8A.

FIG. 8F depicts a sixth output of the fourth example slot type game of FIG. 8A.

FIG. 8G depicts a seventh output of the fourth example slot type game of FIG. 8A.

FIG. 9 depicts a flow chart illustrating a method for providing and/or operating a slot type game with a dynamic payline modifier. The method may be performed by and/or using one or more of the gaming devices and/or the gaming data center of FIGS. 1-2C and/or using the game processing architecture of FIG. 3.

FIG. 10 depicts a flow chart illustrating a method for providing and/or operating a slot type game with a dynamic payline and a dynamic payline modifier. The method may be performed by and/or using one or more of the gaming devices and/or the gaming data center of FIGS. 1-2C and/or using the game processing architecture of FIG. 3.

FIG. 11A depicts a first output of a fifth example slot type game with a dynamic payline modifier. This first example slot type game may be provided by the method of FIG. 9.

FIG. 11B depicts a second output of the fourth example slot type game of FIG. 11A.

FIG. 11C depicts a third output of the fourth example slot type game of FIG. 11A.

FIG. 11D depicts a fourth output of the fourth example slot type game of FIG. 11A.

### DETAILED DESCRIPTION

The present disclosure relates to slot type games with dynamic paylines and/or dynamic payline modifiers. The slot type game includes a grid or matrix of symbols for which one or more symbol outcomes may be determined and presented. In embodiments with one or more dynamic paylines, the slot type game also includes at least one payline determination for which one or more payline outcomes may be determined and presented. The payline outcome may correspond to positions of symbols in the grid or matrix and may determine whether or not the corresponding symbols in the grid or matrix are winners. In embodiments with one or more dynamic payline modifiers, the slot type game also includes at least one payline modifier for which one or more payline modifier outcomes may be determined and presented. The payline modifier outcome may correspond to positions of symbols in one or more paylines and may determine whether or not the one or more paylines and/or symbols are modified. This may provide enhanced slot type game play over slot type games with fixed paylines.

In some examples, the dynamic payline and/or the payline modifier may determine whether the base slot type game is a winner or not. In other examples, the dynamic payline and/or the payline modifier may be initiated as a bonus game after the base slot type game completes, such as where the dynamic payline adds additional paylines to the payline used in the base slot type game, the dynamic payline enhances the payline used in the base slot type game, the payline modifier enhances the payline used in the base slot type game, and so on. In various examples, the payline determination and/or the payline modifier may be determined in tandem with the symbol outcome. In other examples, the payline determination and/or the payline modifier may be determined before and/or after the symbol outcome and may be used to enhance player anticipation as the payline determination is made. Presentation of the payline determination and/or the payline modifier may iterate through a number of possible payline outcomes before presenting the determined payline outcome, further enhancing player anticipation. The payline determination and/or the payline modifier may be presented using a variety of mechanisms, such as a separate physical and/or virtual reel that indicates the determined payline, indicator lights and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other physical or virtual mechanism that may be used to present the payline determination. In some examples, the payline modifier may be presented using mechanisms used to indicate possible paylines, such as paylines that a player may select prior to playing a game, thus adding payline modifier capabilities to a slot type game without requiring additional hardware, software, and/or other components in order to present a payline modifier. In this way, the dynamic payline and/or the payline modifier may greatly expand the game capabilities of the slot type game without requiring additional rows or columns in the grid, additional symbols, and/or additional hardware and/or software resources beyond those used to determine and present the dynamic payline and/or the payline modifier. Such expanded game capabilities may greatly extend the useful life of the slot type game and/or greatly delay the time when the slot type game machine may be replaced.

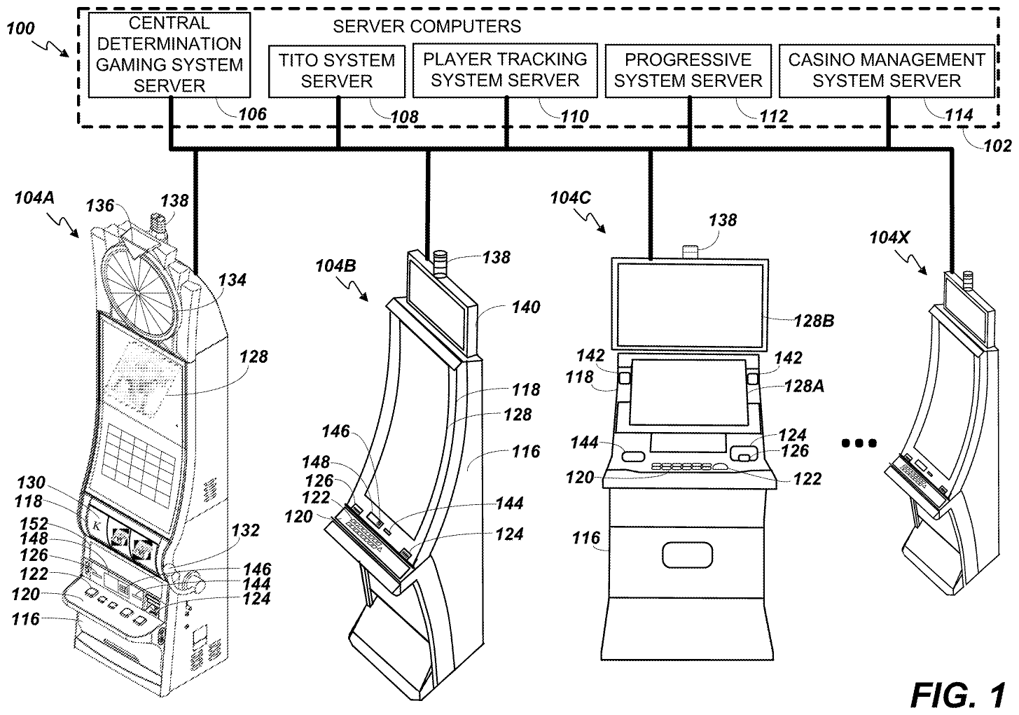

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, and total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

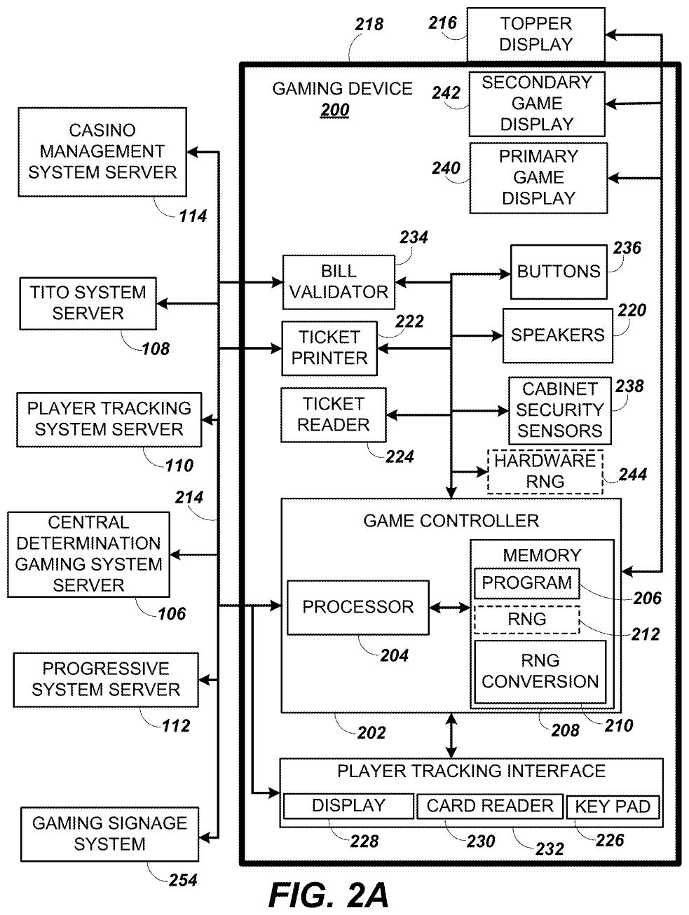

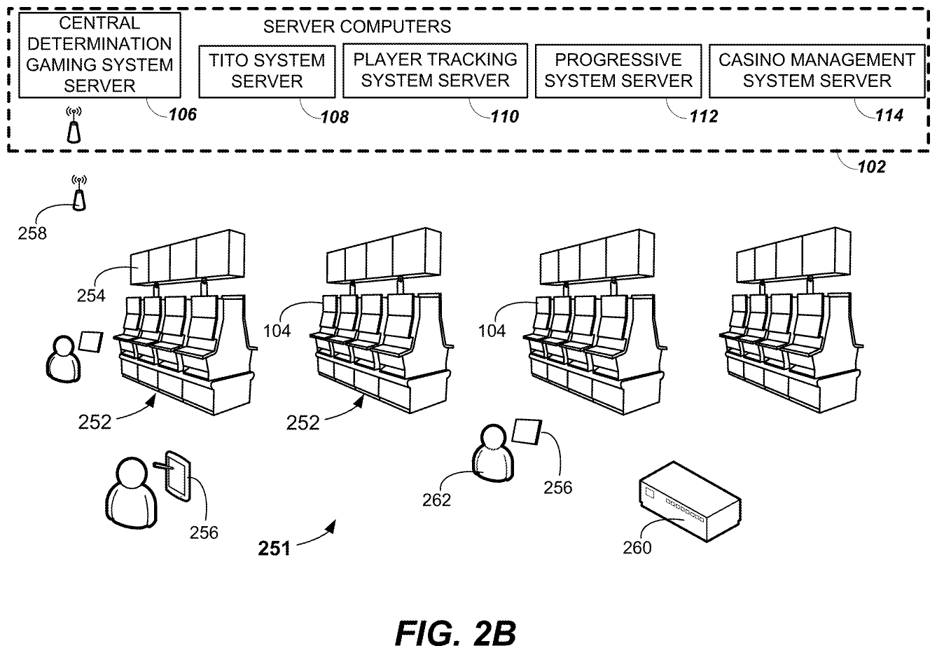

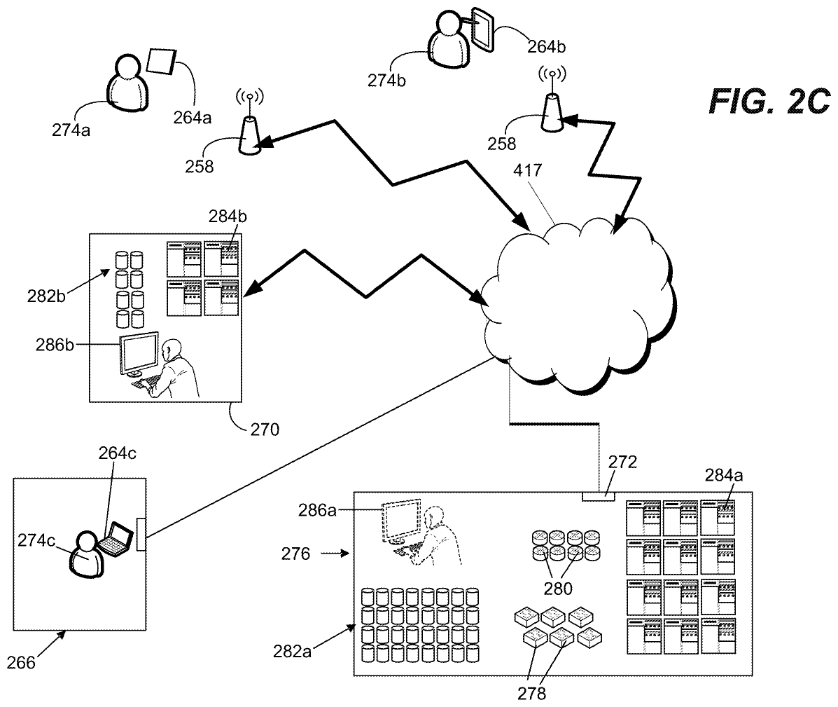

Many or all of the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purposes of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementations, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2A. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2A are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such as EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

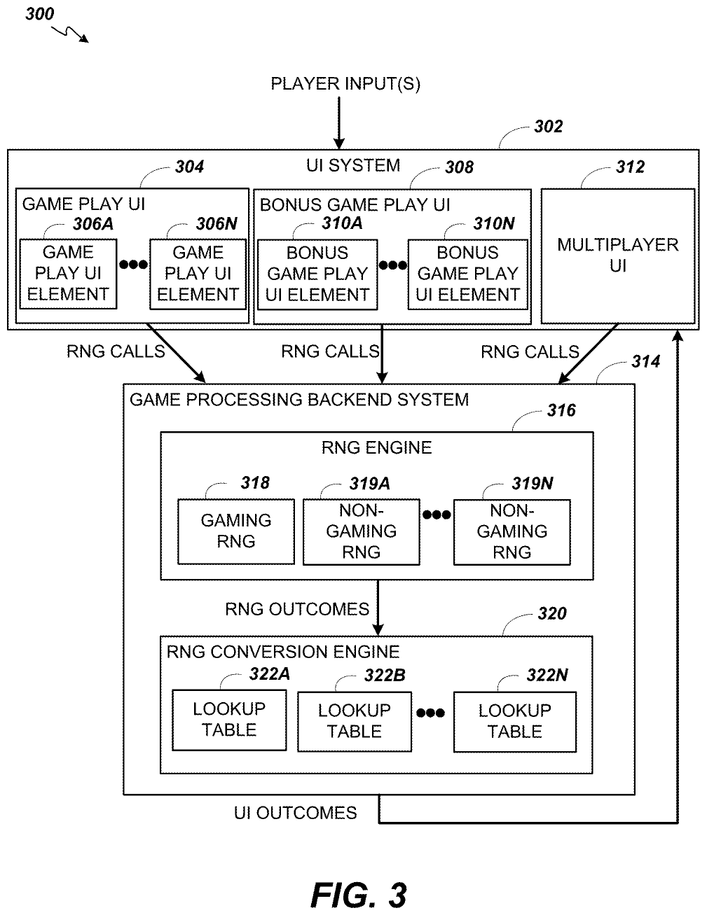

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2A, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI elements 306A-306N are similar to the bonus game play UI elements 310A-310N. In other implementations, the game play UI elements 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

The UI system 302 may receive user input from one or more players to initiate a slot type game with a dynamic payline via one or more game play UIs 304 and/or one or more bonus game play UIs 308. Based on the user input, the UI system 302 may generate one or more RNG calls to the game processing back end 314 to determine one or more symbol outcomes and/or one or more payline determinations. The determined one or more symbol outcomes and/or one or more payline determinations may then be presented via the one or more game play UIs 304 and/or one or more bonus game play UIs 308.

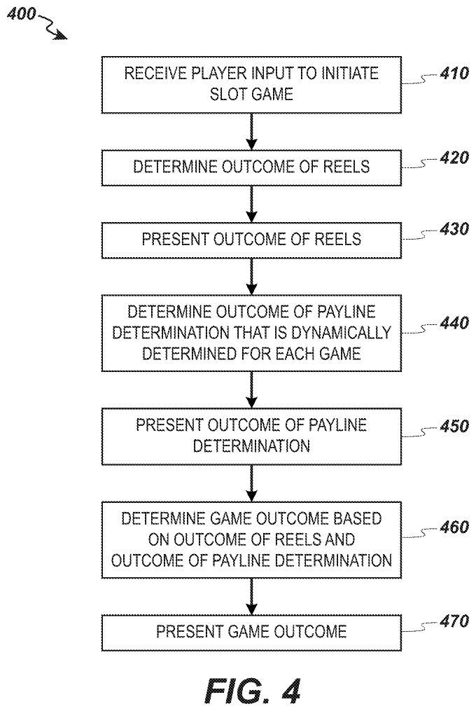

FIG. 4 depicts a flow chart illustrating a method 400 for providing and/or operating a slot type game with a dynamic payline. The method 400 may be performed by and/or using one or more of the gaming devices 104A-104X, 200 and/or the gaming data center 276 of FIGS. 1-2C and/or using the game processing architecture 300 of FIG. 3.

At operation 410, one or more electronic devices (such as one or more of the gaming devices 104A-104X, 200 and/or the gaming data center 276 of FIGS. 1-2C and/or using the game processing architecture 300 of FIG. 3) may receive player input to initiate a slot type game. The slot type game may include one or more symbol reels and/or other grid or matrix of symbols for which one or more symbol outcomes may be determined. The slot type game may also include at least one payline determination for which one or more payline outcomes may be determined.

At operation 420, the electronic device(s) may determine the outcome of the symbol reels. The symbol reels may be mechanical reels, virtual reels presented on a display, and so on.

For example, the outcome of the symbol reels may be determined using a RNG to randomly determine the outcome of the symbol reels. The game may be designed to return a certain percentage of the amount wagered back to the player over the course of many plays or instances of the game, which is generally referred to as RTP. The RTP and randomness of the RNG ensure the fairness of the games and are highly regulated. Upon initiation of play, the RNG may randomly determine a symbol reel stop position and symbols may then be displayed which correspond to that stop position.

Alternatively and/or additionally, the outcome of the symbol reels (and/or the outcome of the payline determination and/or one or more other outcomes) may correspond to results of one or more bingo games. By way of illustration, receipt of player input to initiate a slot type game may enter the player in the bingo game. The result of the bingo game may be determined and the outcome of the symbol reels (and/or the outcome of the payline determination and/or one or more other outcomes) may be selected and/or presented that corresponds to the result of the bingo game (such as one or more facades or slot type game screens that have an outcome matching that of the result of the bingo game). Various configurations are possible and contemplated without departing from the scope of the present disclosure.

At operation 430, the electronic device(s) may present the outcome of the symbol reels. For example, the outcome of the symbol reels may include determining a position at which to stop the symbol reels and presenting that outcome may include physically and/or virtually spinning the symbol reels and stopping the symbol reels at the determined position.

At operation 440, the electronic device(s) may determine the outcome of the payline determination that is dynamically determined for each game. In a typical slot game, only a fixed path through the grid or matrix is the payline and only symbols along that fixed path are evaluated to determine whether a combination of winning symbols is present, the other symbols being ignored. By way of contrast, the payline determination may spin and/or otherwise iterate through various payline determination possibilities dynamically for each game. The payline determination may have a different outcome for each game, although different games may coincidentally have the same payline determination outcome. The outcome of the payline determination may correspond to one of those various payline determination possibilities. The outcome of the payline determination may determine which symbols (i.e., only those along one of the various payline determination possibilities selected as the outcome) are evaluated to determine whether a combination of winning symbols is present, the other symbols being ignored.

For example, the outcome of the payline determination may be determined using a RNG, and may be subject to RTP. Upon initiation of play, the RNG may randomly determine a payline determination outcome and a payline determination may then be selected which corresponds to that outcome. Various configurations are possible and contemplated without departing from the scope of the present disclosure.

By way of another example, the outcome of the payline determination may be selected based on the results of a bingo game into which a player is entered upon initiation of play. In implementations where the outcome of the symbol reels was selected based on the results of a bingo game, the results of the bingo game may be the same results upon which selection of the outcome of the symbol reels was based.

In another example, the outcome of the symbol reels and the payline determination may be determined using a RNG to randomly determine the symbol reels and the payline determination. The RTP and randomness of the RNG ensure the fairness of the games and are highly regulated. Upon initiation of play, the RNG may randomly determine a symbol reel outcome and a payline determination outcome and symbols and a payline may then be selected which correspond to that outcome. Various configurations are possible and contemplated without departing from the scope of the present disclosure.

In some examples, winning symbol combinations may occur with a different (i.e., lesser or more) frequency in slot games with dynamic paylines than in typical slot games with fixed paylines. In such examples, the payline determination may be combined with the reel determination in order to maintain the particular RTP. Various configurations are possible and contemplated without departing from the scope of the present disclosure.

For example, in some implementations, winning symbol combinations may occur more frequently in slot games with dynamic paylines than in typical slot games with fixed paylines. By way of illustration, the symbol reels may display more winning combinations than might be the case in slot games with dynamic paylines than in typical slot games with fixed paylines and the payline determination may be used to “cut down” the actual wins/payouts in order to maintain the particular RTP. Various configurations are possible and contemplated without departing from the scope of the present disclosure.

By way of another example, in some implementations, winning symbol combinations may occur more or fewer in slot games with dynamic paylines than in typical slot games with fixed paylines. By way of illustration, the symbol reels may display fewer winning combinations than might be the case in slot games with dynamic paylines than in typical slot games with fixed paylines and the payline determination may be used to “increase” the actual wins/payouts in order to maintain the particular RTP. Various configurations are possible and contemplated without departing from the scope of the present disclosure.

In various examples, the outcome of the payline determination may be determined separately from the outcome of the symbol reels. For example, the two outcomes may be determined separately using the RNG in order to maintain the particular RTP in a way that neither of the two outcomes are dependent upon each other. In other examples, the two outcomes may be determined separately using the RNG in order to maintain the particular RTP in a way that a second of the two outcomes is determined dependent upon the first of the two outcomes. In still other example, the two outcomes may be the result of a single determination that includes the symbol reel outcome and the payline determination outcome and is determined using the RNG in order to in order to maintain the particular RTP. Various configurations are possible and contemplated without departing from the scope of the present disclosure.

At operation 450, the electronic device(s) may present the outcome of the payline determination. The payline determination may be presented using a variety of mechanisms, such as a separate mechanical and/or virtual reel that indicates the outcome of payline determination, indicator lights and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other mechanical or virtual mechanism that may be used to present the outcome of the payline determination.

At operation 460, the electronic device(s) may determine one or more game outcomes based on the outcome of the symbol reels and the outcome of the payline determination. For example, the electronic device(s) may determine whether or not the position of the symbols based on the outcome of the symbol reels corresponding to the outcome of the payline determination is a winner or not (the other symbols being ignored), whether or not such corresponds to any kind of multiplier and/or enhancement and/or bonus game, and so on.

At operation 470, the electronic device(s) may present the game outcome. For example, the electronic device(s) may indicate whether or not the game is a winner, an amount won, a current credit amount, and so on.

In some examples, the dynamic payline may determine whether the base slot type game is a winner or not. By way of illustration, only symbols corresponding to the outcome of the determined dynamic payline may be evaluated for determining the game outcome. However, it is understood that this is an example and that other configurations are possible and contemplated without departing from the scope of the present disclosure.

In other examples, the dynamic payline may be initiated as a bonus game after the base slot type game completes, such as where the dynamic payline adds additional paylines to the payline used in the base slot type game, the dynamic payline enhances the payline used in the base slot type game, and so on. By way of illustration, a center row of a set of symbol reels may correspond to a fixed payline and may be used to determine a game outcome. Upon completion of the game, one or more dynamic paylines may be determined (such as in response to a player paying to bet one or more additional paylines, as a bonus triggered by one or more results of the game outcome and/or presence of a bonus triggering symbol in the game outcome, and so on) that may multiply and/or enhance the game outcome.

In still other examples, the dynamic payline may change the result of a fixed payline game outcome. By way of illustration, the fixed result payline game outcome may not be a winner, but the dynamic payline may be a winner. By way of another illustration, the fixed result payline game outcome may be a winner, the dynamic payline may be an additional winner, a multiplier and/or enhancement for the fixed payline game outcome may be applied to the fixed result payline game outcome, and so on. By way of another illustration, the fixed result payline game outcome may be a winner, but the dynamic payline may change the fixed result payline game outcome to a non-winner. In such examples, odds of winning for subsequent games may be modified based on the fact that a winning outcome was changed to a non-winning outcome in order to comply with RTP and/or regulatory requirements.

In various examples, the payline determination may be determined in tandem with the symbol outcome. By way of illustration, the symbol reels may spin and/or otherwise iterate through a number of possibilities before stopping at a symbol outcome position at the same time and/or substantially the same time that the payline determination mechanism spins and/or otherwise iterates through a number of possibilities before stopping at a payline determination outcome position.

In other examples, the payline determination may be determined before and/or after the symbol outcome and may be used to enhance player anticipation as the payline determination is made. Presentation of the payline determination may iterate through a number of possible payline outcomes before presenting the determined payline outcome, further enhancing player anticipation. By way of illustration, the symbol reel outcome may be determined and presented before the payline determination is determined and presented so that a player may see how the determined symbol reel outcome corresponds to different payline determinations as different payline determinations are iterated through before the payline determination outcome is presented. By way of another illustration, the payline determination may be determined and presented before the symbol reel outcome is determined and presented so that a player may see how the determined payline determination corresponds to different symbol reel outcomes as different symbol reel outcomes are iterated through before the symbol reel outcome is presented.

In this way, the dynamic payline may greatly expand the game capabilities of the slot type game without requiring additional rows or columns in the grid, additional symbols, and/or additional hardware and/or software resources beyond those used to determine and present the dynamic payline. Such expanded game capabilities may greatly extend the useful life of the slot type game and/or greatly delay the time when the slot type game machine may be replaced.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrates and describes determination and presentation of the symbol reel outcome as linear, sequential operations performed prior to the linear, sequential operations of determination and presentation of the payline determination. However, it is understood that this is an example. In various implementations, such operations may be performed in any kind of order without departing from the scope of the present disclosure.

By way of another example, the method 400 illustrates and describes determination and presentation of the game outcome as separate from determination and presentation of the symbol reel outcome and the payline determination. However, it is understood that this is an example. In some implementations, determination and presentation of the game outcome may be performed by determining and presenting of the symbol reel outcome and the payline determination. Various configurations are possible and contemplated without departing from the scope of the present disclosure.

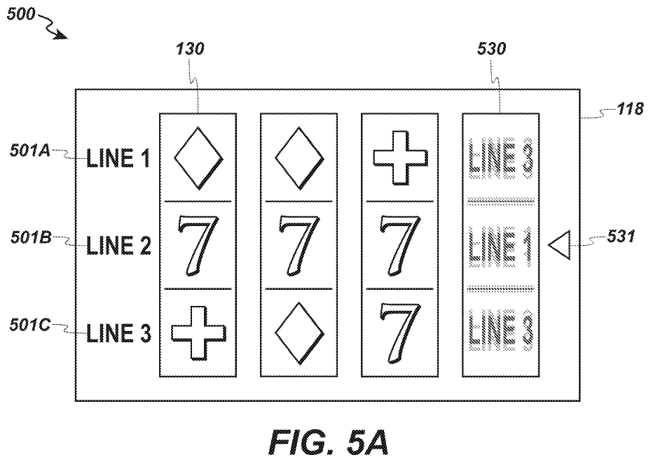

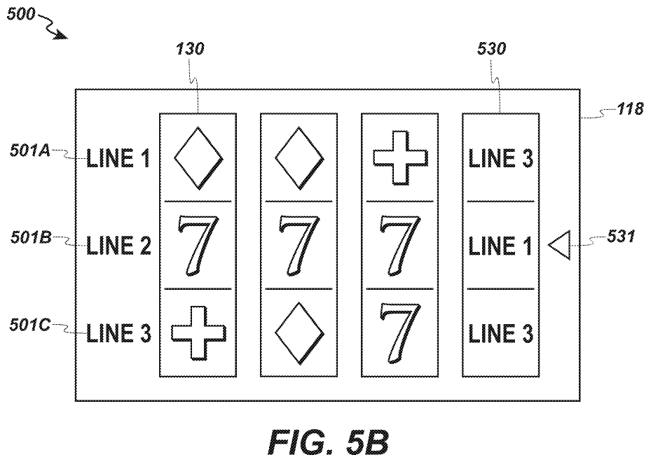

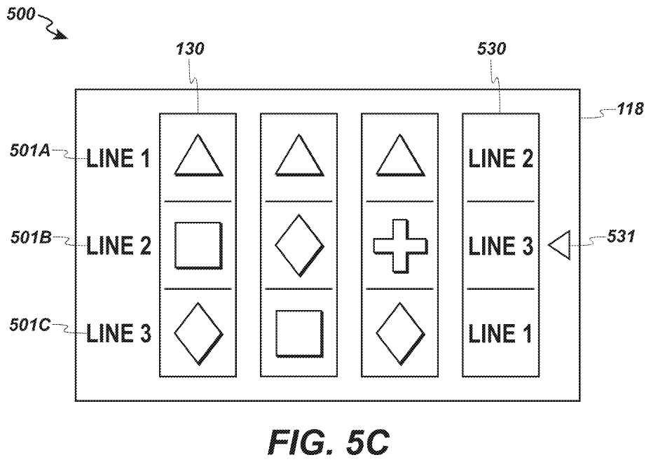

FIG. 5A depicts a first example slot type game 500 with a dynamic payline. This first example slot type game 500 may be provided by the method 400 of FIG. 4.

This first example slot type game 500 may be provided via the gaming display area 118 including the mechanical reels 130 of the gaming device 104A of FIG. 1. Although this example illustrates and describes the mechanical reels 130 as mechanical, in other examples one or more virtual reels may be displayed on one or more displays instead of using the mechanical reels 130. For each game, the mechanical reels 130 may spin and/or otherwise iterate through various symbol possibilities before stopping at a reel outcome position.

In this example, the gaming display area 118 defines three paylines 501A Line 1, 501B Line 2, and 501C Line 3. These three paylines 501A Line 1, 501B Line 2, and 501C Line 3 may represent the different possible payline determinations along paths through the mechanical reels 130 (shown as rows of the mechanical reels 130 in this example) where matching combinations of symbols may indicate the outcome of the game. The payline may be dynamic for the first example slot type game 500 as the outcome of the payline determination, or which of the three paylines 501A Line 1, 501B Line 2, and 501C Line 3 is the payline for the game, may be determined for each game played.

Further in this example, the gaming display area 118 includes a physical payline determination reel 530 and a payline determination indicator 531. Although this example illustrates and describes the physical payline determination reel 530 as mechanical, in other examples one or more physical payline determination reels and/or payline determination indicators may be displayed on one or more displays instead of using the physical payline determination reel 530. Similar to the mechanical reels 130, the payline determination reel 530 may spin and/or otherwise iterate through various payline determination possibilities (i.e., the three paylines 501A Line 1, 501B Line 2, and 501C Line 3) for each game before stopping at a payline determination outcome position where one of the payline determinations is indicated by the payline determination indicator 531. In this example, only the payline determination indicated by the payline determination indicator 531 may be the path through the mechanical reels 130 (shown as rows of the mechanical reels 130 in this example) where matching combinations of symbols may indicate the outcome of the game. The payline determination may be dynamic as the payline determination may be determined for each game.

In FIG. 5A, the physical payline determination reel 530 is shown as still spinning and/or otherwise iterating through various payline determination possibilities. FIG. 5B depicts the first example slot type game 500 of FIG. 5A after the outcome of a dynamic payline determination is presented.

In this example, the payline determination indicator 531 indicates the position on the payline determination reel 530 that displays “Line 1.” The path through (row in this example) the mechanical reels 130 corresponding to 501A Line 1 includes two diamond symbol and a plus symbol. Since the path through (row in this example) the mechanical reels 130 corresponding to 501A Line 1 lacks a combination of winning symbols, the game outcome may be a non-winner.

However, the path through the mechanical reels 130 corresponding to 501B Line 2 includes three seven symbols. Had the position on the payline determination reel 530 indicated by the payline determination indicator 531 displayed “Line 2,” the game outcome may have been a winner because the path through the mechanical reels 130 corresponding to 501B Line 2 would have included a combination of winning symbols.

FIG. 5C depicts a subsequent play of the first example slot type game 500 of FIG. 5B where an outcome of a subsequent dynamic payline is determined and presented. In this example, the payline determination indicator 531 indicates the position on the payline determination reel 530 that displays “Line 3.” The path through (row in this example) the mechanical reels 130 corresponding to 501C Line 3 includes two diamond symbol and a square symbol. Since the path through (row in this example) the mechanical reels 130 corresponding to 501C Line 3 lacks a combination of winning symbols, the game outcome may be a non-winner.

However, the path through the mechanical reels 130 corresponding to 501A Line 1 includes three triangle symbols. Had the position on the payline determination reel 530 indicated by the payline determination indicator 531 displayed “Line 1,” the game outcome may have been a winner because the path through the mechanical reels 130 corresponding to 501A Line 1 would have included a combination of winning symbols.

Although this first example slot type game 500 is illustrated and described in the context of a specific configuration, it is understood that this is an example and that other configurations are possible and contemplated without departing from the scope of the present disclosure. For example the payline determination reel 530 is illustrated and described as presenting a different payline at each position on the payline determination reel 530. However, it is understood that this is an example and that other configurations are possible. For example, in some implementations, the payline determination reel 530 may include one or more blank positions and/or other symbols and/or indicators. Various configurations are possible and contemplated without departing from the scope of the present disclosure.

Further, although the paylines 501A Line 1, 501B Line 2, and 501C Line 3 are illustrated and described as corresponding to rows of the mechanical reels 130, it is understood that this is an example. In other implementations, one or more payline determination indicators may point to and/or otherwise indicate one or more columns of the mechanical reels 130 and/or other groupings of symbols aside from rows and/or columns. Various configurations are possible and contemplated without departing from the scope of the present disclosure.

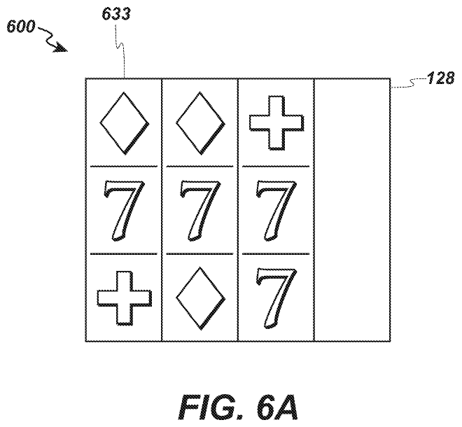

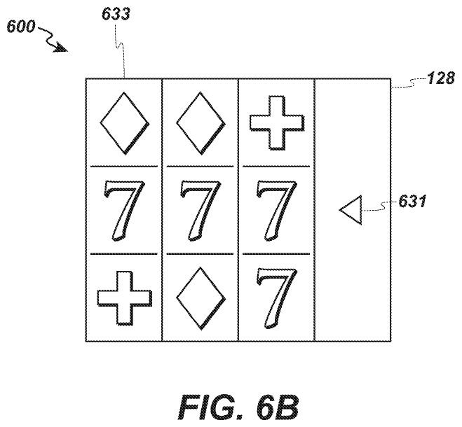

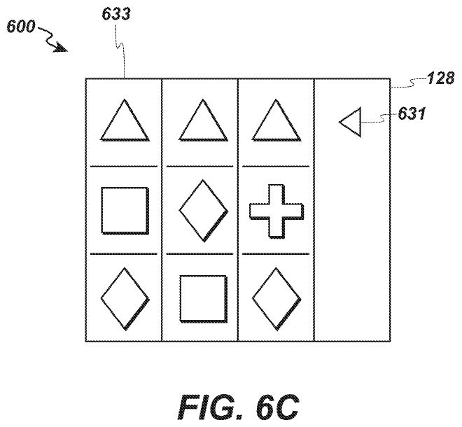

FIG. 6A depicts a second example slot type game 600 with a dynamic payline. This second example slot type game 600 may be provided by the method 400 of FIG. 4. In this example, a set of virtual reels 633 and a virtual payline determination indicator 631 may be displayed on one or more displays, such as the main display 128 of the gaming device 104B, the main display 128A of the gaming device 104C of FIG. 1, and/or the secondary display 128B of the gaming device 104C of FIG. 1).

When a player spins the reels or otherwise initiates the game, the virtual reels 633 may “spin” to select a set of symbols or otherwise be randomized, or the symbols on the virtual reels may be selected according to an algorithm. The virtual reels may “stop” to show the player the set of symbols. As shown in FIG. 6A, the symbols may be arranged in a three by three array, although this is but one example and other arrays may be used.

In this example, the virtual reels 633 may define three paylines that correspond to rows of the virtual reels 633. These three paylines may represent the different possible payline determinations where matching combinations of symbols may indicate the outcome of the game. The payline may be dynamic for the second example slot type game 600 as the outcome of the payline determination, or which of the three paylines is the payline for the game, may be determined for each game played. The outcome of the payline determination may be indicated by a virtual payline determination indicator 631, shown in FIG. 6B.

Similar to the virtual reels 633, the payline determination may spin and/or otherwise iterate through various payline determination possibilities for each game before stopping at a payline determination outcome position where one of the payline determinations is indicated by the payline determination indicator 631. In this example, only the payline determination indicated by the payline determination indicator 631 may be the row of the virtual reels 633 where matching combinations of symbols may indicate the outcome of the game. The payline determination may be dynamic as the payline determination may be determined for each game.

In FIG. 6A, the payline determination indicator 631 is not shown as the payline determination may still be spinning or otherwise iterating through various payline determination possibilities. FIG. 6B depicts the second example slot type game 600 of FIG. 6A after the outcome of a dynamic payline determination is presented via the payline determination indicator 631.

In this example, the payline determination indicator 631 points to the middle row of the virtual reels 633. The middle row of the virtual reels 633 includes three seven symbols. As such, the game outcome may be a winner.

FIG. 6C depicts a subsequent play of the second example slot type game 600 of FIG. 6B where an outcome of a subsequent dynamic payline is determined and presented. In this example, the payline determination indicator 631 indicates the first row of the virtual reels 633. The first row of the virtual reels 633 includes three triangles. As such, the game outcome may be a winner.

Although FIGS. 6A-6C are illustrated and described as presenting the virtual reels 633 and the payline determination indicator 631 via one or more displays, it is understood that this is an example. In other implementations, mechanical reels and/or mechanical payline determination indicators may be used without departing from the scope of the present disclosure.

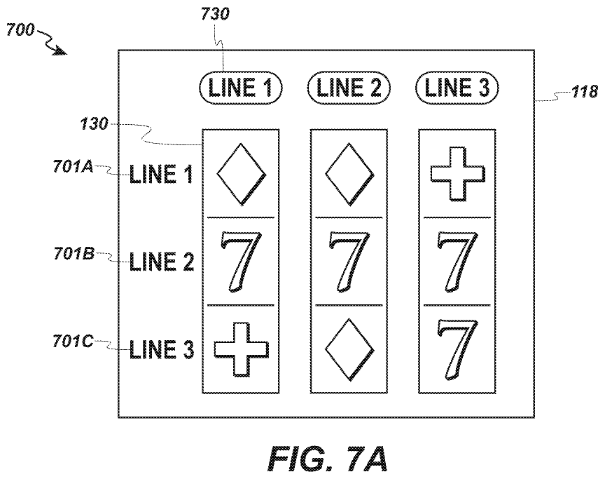

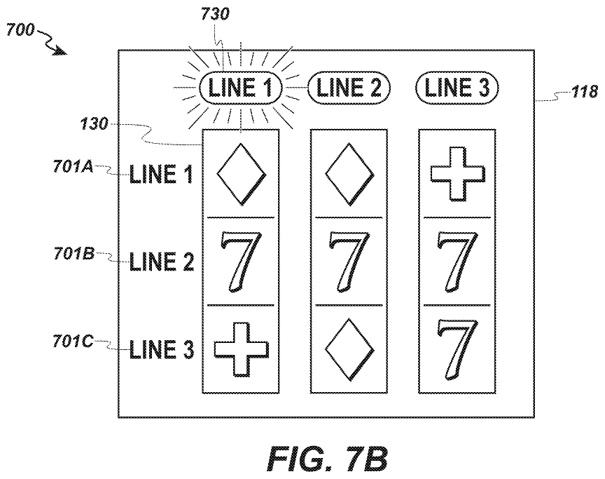

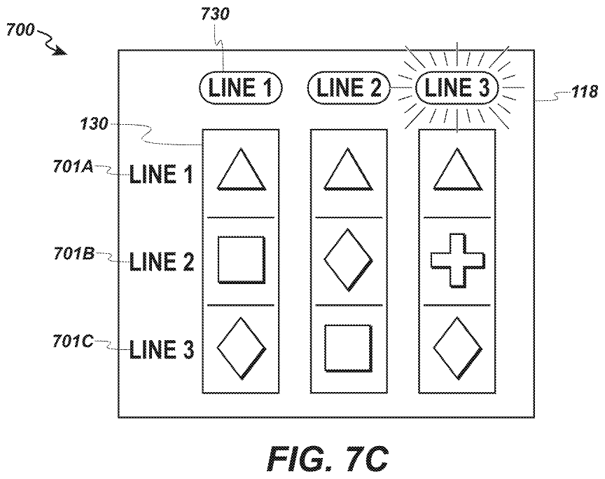

FIG. 7A depicts a third example slot type game 700 with a dynamic payline. This third example slot type game 700 may be provided by the method 400 of FIG. 4.

This third example slot type game 700 may be provided via the gaming display area 118 including the mechanical reels 130 of the gaming device 104A of FIG. 1. Although this example illustrates and describes the mechanical reels 133 as mechanical, in other examples one or more virtual reels may be displayed on one or more displays instead of using the mechanical reels 133. For each game, the mechanical reels 130 may spin and/or otherwise iterate through various symbol possibilities before stopping at a reel outcome position.

In this example, the gaming display area 118 defines three paylines 701A Line 1, 701B Line 2, and 701C Line 3. These three paylines 701A Line 1, 701B Line 2, and 701C Line 3 may represent the different possible payline determinations along paths through the mechanical reels 130 (shown as rows of the mechanical reels 130 in this example) where matching combinations of symbols may indicate the outcome of the game. The payline may be dynamic for the third example slot type game 700 as the outcome of the payline determination, or which of the three paylines 701A Line 1, 701B Line 2, and 701C Line 3 is the payline for the game, may be determined for each game played.

Further in this example, the gaming display area 118 includes payline determination indicators 730. The payline determination indicators 730 may be light mechanisms that illuminate to indicate the outcome of the payline determination. Although this example illustrates and describes the payline determination indicators 730 as mechanical, in other examples one or more physical payline determination reels and/or payline determination indicators may be displayed on one or more displays instead of using the physical payline determination reel 730. Similar to the mechanical reels 130, the payline determination indicators 730 may spin and/or otherwise iterate through various payline determination possibilities (i.e., the three paylines 701A Line 1, 701B Line 2, and 701C Line 3) for each game before stopping at a payline determination outcome position where one of the payline determinations is indicated by which of the payline determination indicators 730 are illuminated. In this example, only the payline determination indicated by the illuminated one of the payline determination indicators 730 may be the path through the mechanical reels 130 (shown as rows of the mechanical reels 130 in this example) where matching combinations of symbols may indicate the outcome of the game. The payline determination may be dynamic as the payline determination may be determined for each game.

In FIG. 7A, the payline determination indicators 730 are all shown as not illuminated as the payline determination may still be spinning and/or otherwise iterating through various payline determination possibilities. FIG. 7B depicts the third example slot type game 700 of FIG. 7A after the outcome of a dynamic payline determination is presented.

For example, the payline determination indicator 730 that displays “Line 1” is shown as illuminated. The row of the mechanical reels 130 corresponding to 701A Line 1 includes two diamond symbols and a plus symbol. As such, the game outcome may be a non-winner. The row of the mechanical reels 130 corresponding to 701B Line 2 includes three seven symbols. Had the payline determination indicator 730 that displays “Line 2” been illuminated, the game outcome may have been a winner.

FIG. 7C depicts a subsequent play of the third example slot type game 700 of FIG. 7B where an outcome of a subsequent dynamic payline is determined and presented. In this example, the payline determination indicator 730 that displays “Line 3” is shown as illuminated. The row of the mechanical reels 130 corresponding to 701C Line 3 includes two diamond symbols and a square symbol. As such, the game outcome may be a non-winner.

However, the row of the mechanical reels 130 corresponding to 701A Line 1 includes three triangle symbols. Had the payline determination indicator 730 that displays “Line 3” been illuminated, the game outcome may have been a winner.

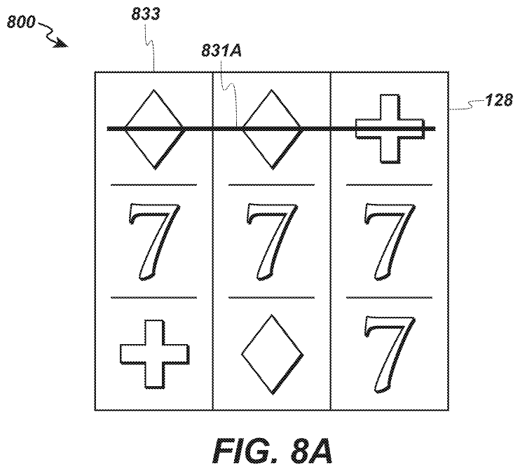

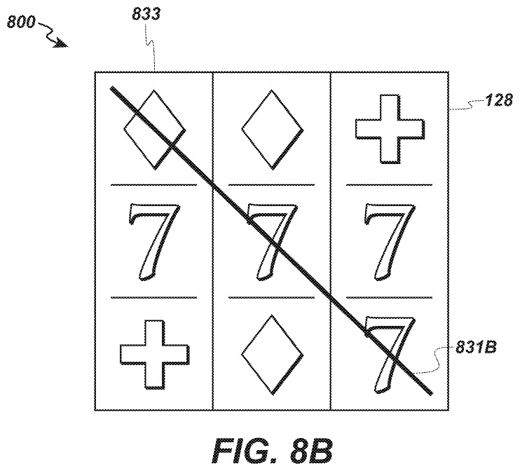

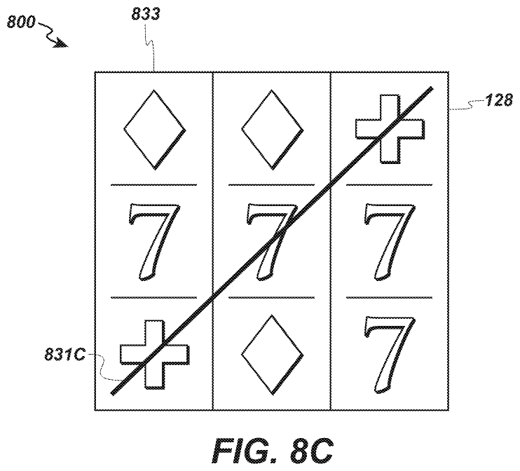

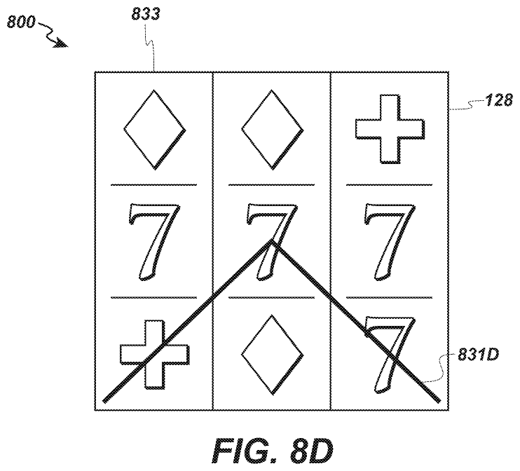

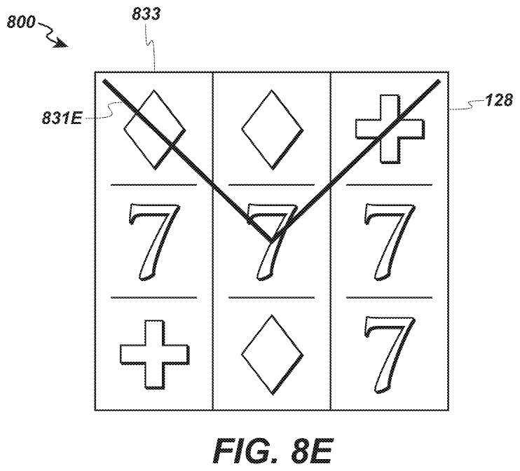

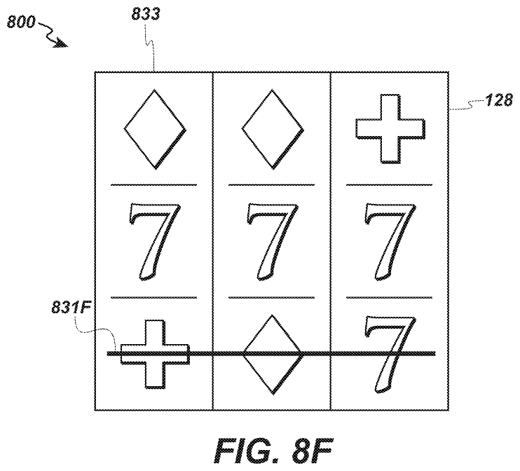

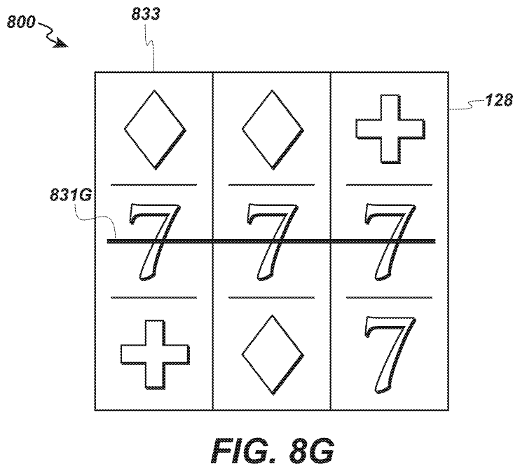

FIGS. 8A-8G depict a sequence of outputs of a fourth example slot type game 800 with a dynamic payline. In this example, a set of virtual reels 833 and a virtual payline determination indicator 831A-G may be displayed on one or more displays, such as the main display 128 of the gaming device 104B, the main display 128A of the gaming device 104C of FIG. 1, and/or the secondary display 128B of the gaming device 104C of FIG. 1).

When a player spins the reels or otherwise initiates the game, the virtual reels 833 may “spin” to select a set of symbols or otherwise be randomized, or the symbols on the virtual reels may be selected according to an algorithm. The virtual reels may “stop” to show the player the set of symbols. As shown in FIG. 8A, the symbols may be arranged in a three by three array, although this is but one example and other arrays may be used.

In this example, the virtual reels 833 may define a number of paylines (shown in FIGS. 8A-8G) that correspond to paths through the virtual reels 833. These paylines may represent the different possible payline determinations where matching combinations of symbols may indicate the outcome of the game. The payline may be dynamic for the fourth example slot type game 800 as the outcome of the payline determination, or which of the paylines is the payline for the game, may be determined for each game played. The outcome of the payline determination may be indicated by a virtual payline determination indicator 831A-831G.

Similar to the virtual reels 833, the payline determination may spin and/or otherwise iterate through various payline determination possibilities for each game before stopping at a payline determination outcome position where one of the payline determinations is indicated by the payline determination indicator 831A-831G. In this example, only the payline determination indicated by the payline determination indicator 831A-831G that is stopped at may be the path through the virtual reels 833 where matching combinations of symbols may indicate the outcome of the game. The payline determination may be dynamic as the payline determination may be determined for each game.

FIG. 8A depicts a first output of the sequence of outputs of the fourth example slot type game 800. FIG. 8B depicts a second output of the fourth example slot type game 800 of FIG. 8A. FIG. 8C depicts a third output of the fourth example slot type game 800 of FIG. 8A. FIG. 8D depicts a fourth output of the fourth example slot type game 800 of FIG. 8A. FIG. 8E depicts a fifth output of the fourth example slot type game 800 of FIG. 8A. FIG. 8F depicts a sixth output of the fourth example slot type game 800 of FIG. 8A. FIG. 8G depicts a seventh output of the fourth example slot type game 800 of FIG. 8A.

In this example, the outcome of the payline determination may stop at the payline determination indicator 831G shown in FIG. 8G. The virtual payline determination indicator 831G may point to the middle line of the virtual reels 833, which includes three seven symbols. As such, the game outcome may be a winner.

Although the above illustrates and describes examples that include single dynamic paylines that can change between games, it is understood that this is an example. In various examples, mechanical and/or virtual payline indicators may point to and/or otherwise indicate multiple rows and/or paths through one or more and/or virtual reels. In some examples, a single dynamic payline may be used in some games and a “bonus” version may be triggered in other games where mechanical and/or virtual payline indicators may point to and/or otherwise indicate multiple rows and/or paths through one or more and/or virtual reels. Such bonus versions may be triggered in accordance with an algorithm, a size of a bet, and so on.

Although dynamic paylines are illustrated and described above in the context of specific game implementations and using specific indicators, it is understood that these are examples and that dynamic paylines may be used in the context of other game implementations and using other indicators without departing from the scope of the present disclosure. For example, in some implementations, a player may be able to bet a sequence of additional paylines that supplement, enhance, and/or multiply a fixed payline. Various configurations are possible and contemplated without departing from the scope of the present disclosure.

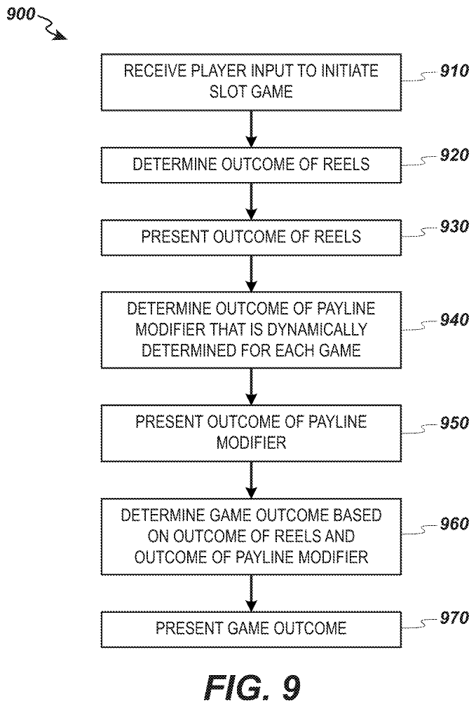

FIG. 9 depicts a flow chart illustrating a method 900 for providing and/or operating a slot type game with a dynamic payline. The method 900 may be performed by and/or using one or more of the gaming devices 104A-104X, 200 and/or the gaming data center 276 of FIGS. 1-2C and/or using the game processing architecture 300 of FIG. 3.

At operation 910, one or more electronic devices (such as one or more of the gaming devices 104A-104X, 200 and/or the gaming data center 276 of FIGS. 1-2C and/or using the game processing architecture 300 of FIG. 3) may receive player input to initiate a slot type game. The slot type game may include one or more symbol reels and/or other grid or matrix of symbols for which one or more symbol outcomes may be determined. The slot type game may also include at least one payline determination for which one or more payline outcomes may be determined.

At operation 920, the electronic device(s) may determine the outcome of the symbol reels. The symbol reels may be mechanical reels, virtual reels presented on a display, and so on.

For example, the outcome of the symbol reels (and/or the outcome of the payline modifier and/or one or more other outcomes) may correspond to results of one or more bingo games. By way of illustration, receipt of player input to initiate a slot type game may enter the player in the bingo game. The result of the bingo game may be determined and the outcome of the symbol reels (and/or the outcome of the payline modifier and/or one or more other outcomes) may be selected and/or presented that corresponds to the result of the bingo game (such as one or more facades or slot type game screens that have an outcome matching that of the result of the bingo game).

Alternatively and/or additionally, the outcome of the symbol reels may be determined using a RNG (which may be subject to RTP) to randomly determine the outcome of the symbol reels. Upon initiation of play, the RNG may randomly determine a symbol reel stop position and symbols may then be displayed which correspond to that stop position. Various configurations are possible and contemplated without departing from the scope of the present disclosure.

At operation 930, the electronic device(s) may present the outcome of the symbol reels. For example, the outcome of the symbol reels may include determining a position at which to stop the symbol reels and presenting that outcome may include physically and/or virtually spinning the symbol reels and stopping the symbol reels at the determined position. Specific matching combinations of symbols along one or more predetermined paths, or paylines, through the outcome of the symbol reels may indicate the outcome of the game, which may be modified by the outcome of the payline modifier. One or more indicators indicating the one or more paylines may be presented.

At operation 940, the electronic device(s) may determine the outcome of one or more payline modifiers that are dynamically determined for each game. The payline modifier may correspond to one or more paths through the outcome of the symbol reels, which may or may not correspond to part and/or all of the one or more paylines. The payline determination may have a different outcome for each game, although different games may coincidentally have the same payline determination outcome. The outcome of the payline modifier may correspond to one of those various payline determination possibilities.

For example, the outcome of the payline modifier may be selected based on the results of a bingo game into which a player is entered upon initiation of play. In implementations where the outcome of the symbol reels was selected based on the results of a bingo game, the results of the bingo game may be the same results upon which selection of the outcome of the symbol reels was based.

By way of another example, the outcome of the payline modifier may be determined using a RNG, and may be subject to RTP. Upon initiation of play, the RNG may randomly determine a payline modifier outcome and a payline modifier may then be selected which corresponds to that outcome. Various configurations are possible and contemplated without departing from the scope of the present disclosure.

At operation 950, the electronic device(s) may present the outcome of the payline modifier. The payline modifier may be presented using a variety of mechanisms, such as a separate mechanical and/or virtual reel that indicates the outcome of a payline modifier, indicator lights, and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other mechanical or virtual mechanism that may be used to present the outcome of the payline modifier. In some examples, the payline modifier may be presented using mechanisms used to indicate possible paylines, such as paylines that a player may select prior to playing a game (such as in examples like implementations where a player may select one or more specific paylines, implementations where a player can select one or more set numbers of additional paylines corresponding to one or more additional bets, and so on), thus adding payline modifier capabilities to a slot type game without requiring additional hardware, software, and/or other components in order to present a payline modifier.

At operation 960, the electronic device(s) may determine one or more game outcomes based on the outcome of the symbol reels (and/or one or more paylines corresponding to the outcome of the one or more symbol reels) and the outcome of the payline modifier. For example, the electronic device(s) may determine whether or not the position of the symbols based on the outcome of the symbol reels corresponding to one or more paylines is a winner or not (the other symbols being ignored), whether or not such corresponds to any kind of multiplier and/or enhancement and/or bonus game, and so on. If the outcome of the symbol reels corresponding to one or more paylines is a winner, the electronic device(s) may determine an award.

The electronic device(s) may then determine whether or not to modify the award based on the payline modifier, such as based on a relationship between one or more paylines and the payline modifier. By way of illustration, the electronic device(s) may determine whether or not the payline modifier intersects one or more symbols along the one or more paylines. The electronic device(s) may modify the award based on the intersection, the number of intersections, and so on.

For example, the electronic device(s) may multiply the award based on the number of symbols along the one or more paylines intersected by the payline modifier. In some implementations, the electronic device(s) may multiply the award by two when one symbol along the one or more paylines is intersected by the payline modifier, by three when two symbols along the one or more paylines are intersected by the payline modifier, by four when three symbols along the one or more paylines are intersected by the payline modifier, by five when four symbols along the one or more paylines are intersected by the payline modifier, and by ten when five symbols along the one or more paylines are intersected by the payline modifier. However, it is understood that this is an example and that other implementations are possible and contemplated without departing from the scope of the present disclosure.

By way of illustration, intersection of the payline modifier and one or more paylines may convert non-winning symbols to winning symbols, may turn various symbols into one or more wild symbols, trigger one or more bonuses and/or bonus games, trigger one or more free spins, enable collection of one or more symbols for one or more progressive, side, and/or other games (such as where a player may collect a sequence of symbols, like ace, king, queen, and jack; a set of a portion of one or more words, like gra, nd, pri, ze, in order to win the one or more progressive, side, and/or other games), and so on. Various configurations are possible and contemplated without departing from the scope of the present disclosure.

At operation 970, the electronic device(s) may present the game outcome. For example, the electronic device(s) may indicate whether or not the game is a winner, an amount won, a current credit amount, and so on.

In some examples, the dynamic payline modifier may be part of initiation game play. However, it is understood that this is an example and that other configurations are possible and contemplated without departing from the scope of the present disclosure. By way of illustration, in other examples, the dynamic payline modifier may be initiated as a bonus game after the base slot type game completes, such as where the dynamic payline modifier may convert a non-winning game into a winning game, the dynamic payline may enhance the award of the base slot type game, and so on. By way of illustration, a center row of a set of symbol reels may correspond to a fixed payline and may be used to determine a game outcome. Upon completion of the game, one or more dynamic payline modifiers may be determined (such as in response to a player paying to bet up the result, as a bonus triggered by one or more results of the game outcome and/or presence of a bonus triggering symbol in the game outcome, and so on) that may multiply and/or otherwise enhance the game outcome.

In various examples, the payline modifier may be determined in tandem with the symbol outcome. By way of illustration, the symbol reels may spin and/or otherwise iterate through a number of possibilities before stopping at a symbol outcome position at the same time and/or substantially the same time that the payline modifier mechanism spins and/or otherwise iterates through a number of possibilities before stopping at a payline modifier outcome position.

In other examples, the payline modifier may be determined before and/or after the symbol outcome and may be used to enhance player anticipation as the payline modifier is made. Presentation of the payline modifier may iterate through a number of possible payline modifier outcomes before presenting the determined payline modifier outcome, further enhancing player anticipation. By way of illustration, the symbol reel outcome may be determined and presented before the payline modifier is determined and presented so that a player may see how the determined symbol reel outcome corresponds to different payline modifiers as different payline modifiers are iterated through before the payline modifier outcome is presented. By way of another illustration, the payline modifier may be determined and presented before the symbol reel outcome is determined and presented so that a player may see how the determined payline modifier corresponds to different symbol reel outcomes as different symbol reel outcomes are iterated through before the symbol reel outcome is presented.

In this way, the dynamic payline modifier may greatly expand the game capabilities of the slot type game without requiring additional rows or columns in the grid, additional symbols, and/or additional hardware and/or software resources beyond those used to determine and present the dynamic payline modifier, which may be the same hardware and/or software resources used to indicate possible paylines and thus may not require additional hardware and/or software resources to present a dynamic payline modifier. Such expanded game capabilities may greatly extend the useful life of the slot type game and/or greatly delay the time when the slot type game machine may be replaced.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 illustrates and describes determination and presentation of the symbol reel outcome as linear, sequential operations performed prior to the linear, sequential operations of determination and presentation of the payline modifier. However, it is understood that this is an example. In various implementations, such operations may be performed in any kind of order without departing from the scope of the present disclosure.

By way of another example, the method 900 illustrates and describes determination and presentation of the game outcome as separate from determination and presentation of the symbol reel outcome and the payline modifier. However, it is understood that this is an example. In some implementations, determination and presentation of the game outcome may be performed by determining and presenting of the symbol reel outcome and the payline modifier. Various configurations are possible and contemplated without departing from the scope of the present disclosure.

In still another example, although the dynamic payline modifier is illustrated and described as being used with a single, static payline, it is understood that this is an example. In various implementations, one or more dynamic payline modifiers may be used with one or more dynamic and/or static paylines. Various configurations are possible and contemplated without departing from the scope of the present disclosure.

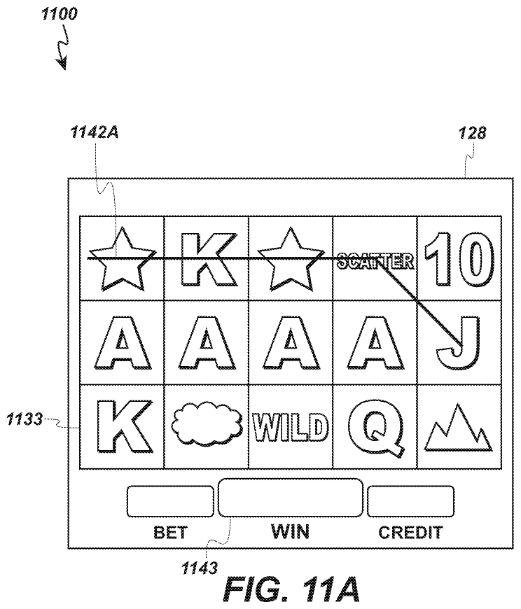

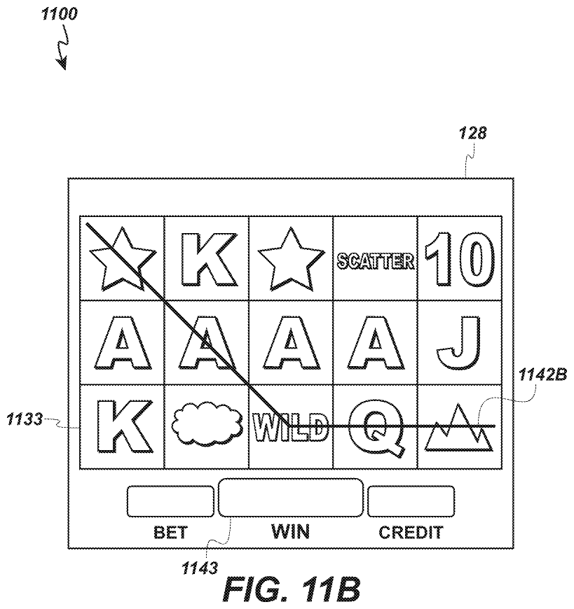

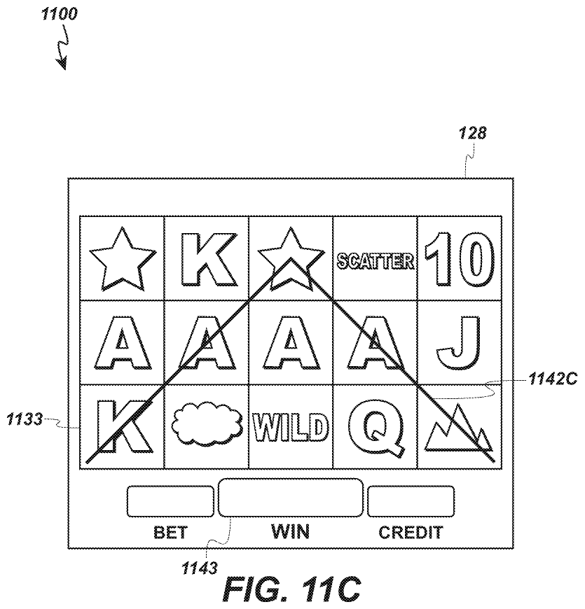

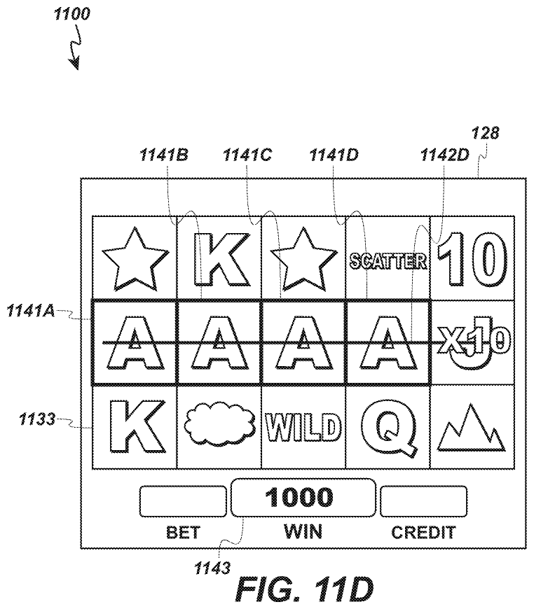

FIG. 11A depicts a first output of a fifth example slot type game with a dynamic payline modifier. This first example slot type game may be provided by the method of FIG. 9.

FIGS. 11A-11D depict a sequence of outputs of a fifth example slot type game 1100 with a dynamic payline modifier. In this example, a set of virtual reels 1133, payline winning symbol indicators 1141A-1141D, a win indicator 1143, and a virtual payline modifier indicator 1142A-1142D may be displayed on one or more displays, such as the main display 128 of the gaming device 104B, the main display 128A of the gaming device 104C of FIG. 1, and/or the secondary display 128B of the gaming device 104C of FIG. 1).

When a player spins the reels or otherwise initiates the game, the virtual reels 1133 may “spin” to select a set of symbols or otherwise be randomized, or the symbols on the virtual reels may be selected according to an algorithm. For example, receipt of player input to initiate a slot type game may enter the player in a bingo game. The result of the bingo game may be determined and the outcome of the virtual reels 1133 (and/or the outcome of the payline modifier and/or one or more other outcomes) may be selected and/or presented that corresponds to the result of the bingo game (such as one or more facades or slot type game screens that have an outcome matching that of the result of the bingo game). The virtual reels may “stop” to show the player the set of symbols. As shown in FIG. 11A, the symbols may be arranged in a five by three array, although this is but one example and other arrays may be used.

In this example, the virtual reels 1133 may define a number of payline modifiers (shown in FIGS. 11A-11D) that correspond to paths through the virtual reels 1133. These payline modifiers may represent the different possible payline determinations where matching combinations of symbols may indicate the outcome of the game. The payline modifiers may be dynamic for the fifth example slot type game 1100 as the outcome of the payline determination, or which of the payline modifiers is the payline modifier for the game, may be determined for each game played. The outcome of the payline determination may be indicated by a virtual payline determination indicator 1142A-1142D.

Similar to the virtual reels 1133, the payline modifier may spin and/or otherwise iterate through various payline modifier possibilities for each game before stopping at a payline modifier outcome position where one of the payline modifiers is indicated by the payline modifier indicator 1142A-1142D. In this example, only the payline modifier indicated by the payline determination indicator 1142A-1142D that is stopped at may be the path through the virtual reels 1133 that may modify results of matching combinations of symbols along a payline indicating the outcome of the game. The payline modifier may be dynamic as the payline modifier may be determined for each game.

In this example, the payline modifier may multiply an award corresponding to matching combinations of symbols along a payline defined by a center row of the virtual reel 1133. The payline modifier may multiply the award based on the number of symbols along the payline intersected by the payline modifier. The award may be multiplied by two when one symbol along the payline is intersected by the payline modifier, by three when two symbols along the payline are intersected by the payline modifier, by four when three symbols along the payline are intersected by the payline modifier, by five when four symbols along the one or more paylines are intersected by the payline modifier, and by ten when five symbols along the payline are intersected by the payline modifier. However, it is understood that this is an example and that other implementations are possible and contemplated without departing from the scope of the present disclosure.

By way of example, other modifications besides multipliers may be used in one or more implementations. Such other modifications are discussed elsewhere herein.

FIG. 11A depicts a first output of the sequence of outputs of the fourth example slot type game 1100. FIG. 11B depicts a second output of the fourth example slot type game 1100 of FIG. 11A. FIG. 11C depicts a third output of the fourth example slot type game 1100 of FIG. 11A. FIG. 11D depicts a fourth output of the fourth example slot type game 1100 of FIG. 11A.

In this example, the outcome of the payline modifier may stop at the payline modifier indicator 1142D shown in FIG. 11D. The virtual payline modifier indicator 1142D may overlap the payline defined by the center row of the virtual reel 1133, which includes four ace symbols. The combination of four ace symbols may be defined as a winning combination. As such, the game outcome may be a winner and the four ace symbols may be indicated using the payline winning symbol indicators 1141A-1141D. The Jack symbol on the payline with the four ace symbols may not be part of the winning combination of the four aces and thus may not be indicated using a payline winning symbol indicator. The award for the combination of the four ace symbols may be 100. However, the virtual payline modifier indicator 1142D intersects five symbols along the payline defined by the center row of the virtual reel 1133. As such, the 100 award may be multiplied by 10 for a 1000 final outcome shown by the win indicator 1143 in FIG. 11D.

By way of contrast, the virtual payline modifier indicator 1142A of FIG. 11A intersects no symbols along the payline defined by the center row of the virtual reel 1133. Had this corresponded to the virtual payline modifier, the award may not have been modified. Similarly, the virtual payline modifier indicator 1142B of FIG. 11B intersects one symbol along the payline defined by the center row of the virtual reel 1133. Had this corresponded to the virtual payline modifier, the award may have been multiplied by two for a 200 final outcome. Similarly, the virtual payline modifier indicator 1142C of FIG. 11C intersects two symbols along the payline defined by the center row of the virtual reel 1133. Had this corresponded to the virtual payline modifier, the award may have been multiplied by three for a 300 final outcome.

Although the above illustrates and describes examples that include a single dynamic payline modifier that can change between games, it is understood that this is an example. In various examples, mechanical and/or virtual payline modifier indicators may point to and/or otherwise indicate multiple rows and/or paths through one or more and/or virtual reels. In some examples, the dynamic payline modifier may be initiated as a bonus game after the base slot type game completes, such as where the dynamic payline modifier enhances the payline used in the base slot type game, and so on.

Although dynamic payline modifiers are illustrated and described above in the context of specific game implementations and using specific indicators, it is understood that these are examples and that dynamic payline modifiers may be used in the context of other game implementations and using other indicators without departing from the scope of the present disclosure. Various configurations are possible and contemplated without departing from the scope of the present disclosure.

Although the dynamic payline modifier is illustrated and described as being used with a single, static payline, it is understood that this is an example. In various implementations, one or more dynamic payline modifiers may be used with one or more dynamic and/or static paylines. Various configurations are possible and contemplated without departing from the scope of the present disclosure.

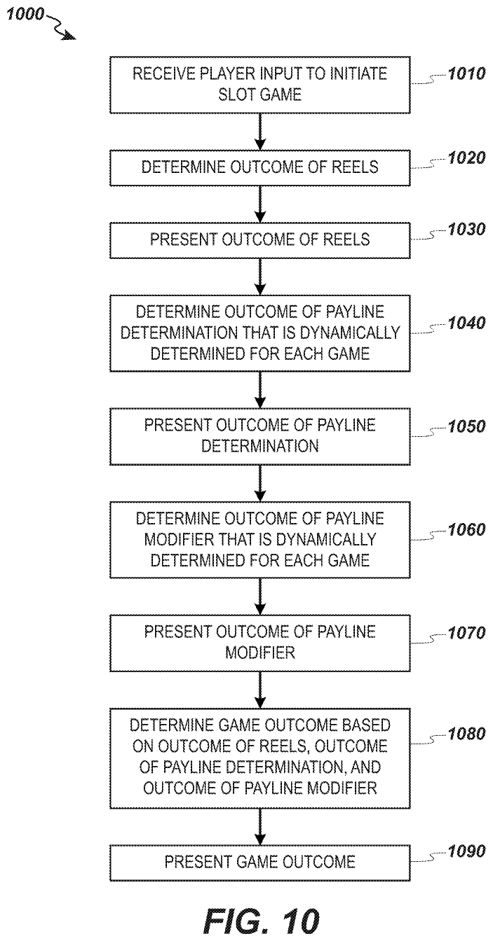

FIG. 10 depicts a flow chart illustrating a method 1000 for providing and/or operating a slot type game with a dynamic payline and a dynamic payline modifier. The method 1000 may be performed by and/or using one or more of the gaming devices 104A-104X, 200 and/or the gaming data center 276 of FIGS. 1-2C and/or using the game processing architecture 300 of FIG. 3.

At operation 1010, one or more electronic devices (such as one or more of the gaming devices 104A-104X, 200 and/or the gaming data center 276 of FIGS. 1-2C and/or using the game processing architecture 300 of FIG. 3) may receive player input to initiate a slot type game. The slot type game may include one or more symbol reels and/or other grid or matrix of symbols for which one or more symbol outcomes may be determined. The slot type game may also include at least one payline determination for which one or more payline outcomes may be determined.

At operation 1020, the electronic device(s) may determine the outcome of the symbol reels. The symbol reels may be mechanical reels, virtual reels presented on a display, and so on.

For example, the outcome of the symbol reels (and/or the outcome of the payline modifier and/or one or more other outcomes) may correspond to results of one or more bingo games. By way of illustration, receipt of player input to initiate a slot type game may enter the player in the bingo game. The result of the bingo game may be determined and the outcome of the symbol reels (and/or the outcome of the payline modifier and/or one or more other outcomes) may be selected and/or presented that corresponds to the result of the bingo game (such as one or more facades or slot type game screens that have an outcome matching that of the result of the bingo game).

Alternatively and/or additionally, the outcome of the symbol reels may be determined using a RNG (which may be subject to RTP) to randomly determine the outcome of the symbol reels. Upon initiation of play, the RNG may randomly determine a symbol reel stop position and symbols may then be displayed which correspond to that stop position. Various configurations are possible and contemplated without departing from the scope of the present disclosure.

At operation 1030, the electronic device(s) may present the outcome of the symbol reels. For example, the outcome of the symbol reels may include determining a position at which to stop the symbol reels and presenting that outcome may include physically and/or virtually spinning the symbol reels and stopping the symbol reels at the determined position.

At operation 1040, the electronic device(s) may determine the outcome of the payline determination that is dynamically determined for each game. In a typical slot game, only a fixed path through the grid or matrix is the payline and only symbols along that fixed path are evaluated to determine whether a combination of winning symbols is present, the other symbols being ignored. By way of contrast, the payline determination may spin and/or otherwise iterate through various payline determination possibilities dynamically for each game. The payline modifier may have a different outcome for each game, although different games may coincidentally have the same payline determination outcome. The outcome of the payline determination may correspond to one of those various payline determination possibilities. The outcome of the payline determination may determine which symbols (i.e., only those along one of the various payline determination possibilities selected as the outcome) are evaluated to determine whether a combination of winning symbols is present, the other symbols being ignored.

For example, the outcome of the payline determination may be selected based on the results of a bingo game into which a player is entered upon initiation of play. In implementations where the outcome of the symbol reels was selected based on the results of a bingo game, the results of the bingo game may be the same results upon which selection of the outcome of the symbol reels was based.

By way of another example, the outcome of the payline determination may be determined using a RNG, and may be subject to RTP. Upon initiation of play, the RNG may randomly determine a payline determination outcome and a payline determination may then be selected which corresponds to that outcome. Various configurations are possible and contemplated without departing from the scope of the present disclosure.

In some examples, winning symbol combinations may occur with a different (i.e., lesser or more) frequency in slot games with dynamic paylines than in typical slot games with fixed paylines. In such examples, the payline determination may be combined with the reel determination in order to maintain the particular RTP. Various configurations are possible and contemplated without departing from the scope of the present disclosure.

For example, in some implementations, winning symbol combinations may occur more frequently in slot games with dynamic paylines than in typical slot games with fixed paylines. By way of illustration, the symbol reels may display more winning combinations than might be the case in slot games with dynamic paylines than in typical slot games with fixed paylines and the payline determination may be used to “cut down” the actual wins/payouts in order to maintain the particular RTP. Various configurations are possible and contemplated without departing from the scope of the present disclosure.

By way of another example, in some implementations, winning symbol combinations may occur more or fewer in slot games with dynamic paylines than in typical slot games with fixed paylines. By way of illustration, the symbol reels may display fewer winning combinations than might be the case in slot games with dynamic paylines than in typical slot games with fixed paylines and the payline determination may be used to “increase” the actual wins/payouts in order to maintain the particular RTP. Various configurations are possible and contemplated without departing from the scope of the present disclosure.

In various examples, the outcome of the payline determination may be determined separately from the outcome of the symbol reels. For example, the two outcomes may be determined separately using the RNG in order to maintain the particular RTP in a way that neither of the two outcomes are dependent upon each other. In other examples, the two outcomes may be determined separately using the RNG in order to maintain the particular RTP in a way that a second of the two outcomes is determined dependent upon the first of the two outcomes. In still other examples, the two outcomes may be the result of a single determination that includes the symbol reel outcome and the payline determination outcome and is determined using the RNG in order to maintain the particular RTP. Various configurations are possible and contemplated without departing from the scope of the present disclosure.

At operation 1050, the electronic device(s) may present the outcome of the payline determination. The payline determination may be presented using a variety of mechanisms, such as a separate mechanical and/or virtual reel that indicates the outcome of payline determination, indicator lights, and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other mechanical or virtual mechanism that may be used to present the outcome of the payline determination.

At operation 1060, the electronic device(s) may determine the outcome of one or more payline modifiers that are dynamically determined for each game. The payline modifier may correspond to one or more paths through the outcome of the symbol reels, which may or may not correspond to part and/or all of the one or more paylines. The payline determination may have a different outcome for each game, although different games may coincidentally have the same payline determination outcome. The outcome of the payline modifier may correspond to one of those various payline determination possibilities.

For example, the outcome of the payline modifier may be selected based on the results of a bingo game into which a player is entered upon initiation of play. In implementations where the outcome of the symbol reels was selected based on the results of a bingo game, the results of the bingo game may be the same results upon which selection of the outcome of the symbol reels was based.

By way of another example, the outcome of the payline modifier may be determined using a RNG, and may be subject to RTP. Upon initiation of play, the RNG may randomly determine a payline modifier outcome and a payline modifier may then be selected which corresponds to that outcome. Various configurations are possible and contemplated without departing from the scope of the present disclosure.

At operation 1070, the electronic device(s) may present the outcome of the payline modifier. The payline modifier may be presented using a variety of mechanisms, such as a separate mechanical and/or virtual reel that indicates the outcome of a payline modifier, indicator lights, and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other mechanical or virtual mechanism that may be used to present the outcome of the payline modifier. In some examples, the payline modifier may be presented using mechanisms used to indicate possible paylines, such as paylines that a player may select prior to playing a game (such as in examples like implementations where a player may select one or more specific paylines, implementations where a player can select one or more set numbers of additional paylines corresponding to one or more additional bets, and so on), thus adding payline modifier capabilities to a slot type game without requiring additional hardware, software, and/or other components in order to present a payline modifier.

At operation 1080, the electronic device(s) may determine one or more game outcomes based on the outcome of the symbol reels, the outcome of the payline determination, and the outcome of the payline modifier. For example, the electronic device(s) may determine whether or not the position of the symbols based on the outcome of the symbol reels corresponding to the outcome of the payline determination is a winner or not (the other symbols being ignored), whether or not such corresponds to any kind of multiplier and/or enhancement and/or bonus game, and so on. The electronic device(s) may determine an award based on whether the outcome of the symbol reels corresponding to the outcome of the payline determination is a winner, and may then modify that award based on the outcome of the payline modifier (such as one or more of the modifications discussed above with respect to FIG. 9).

At operation 1090, the electronic device(s) may present the game outcome. For example, the electronic device(s) may indicate whether or not the game is a winner, an amount won, a current credit amount, and so on.

In this way, the dynamic payline and the dynamic payline modifier may greatly expand the game capabilities of the slot type game without requiring additional rows or columns in the grid, additional symbols, and/or additional hardware and/or software resources beyond those used to determine and present the dynamic payline and the dynamic payline modifier. Such expanded game capabilities may greatly extend the useful life of the slot type game and/or greatly delay the time when the slot type game machine may be replaced.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 illustrates and describes determination and presentation of the symbol reel outcome as linear, sequential operations performed prior to the linear, sequential operations of determination and presentation of the payline determination, which is illustrated and described as linear, sequential operations performed prior to the linear, sequential operations of determination and presentation of the payline modifier. However, it is understood that this is an example. In various implementations, such operations may be performed in any kind of order without departing from the scope of the present disclosure.

By way of another example, the method 1000 illustrates and describes determination and presentation of the game outcome as separate from determination and presentation of the symbol reel outcome, the payline determination, and the payline modifier. However, it is understood that this is an example. In some implementations, determination and presentation of the game outcome may be performed by determining and presenting of the symbol reel outcome, the payline determination, and the payline modifier. Various configurations are possible and contemplated without departing from the scope of the present disclosure.

In various implementations, a system may include at least one non-transitory storage medium storing instructions and at least one processor. The at least one processor may execute the instructions to determine a symbol reel outcome for multiple reels, each reel comprising multiple symbols and the symbol reel outcome comprising multiple symbols displayed at multiple display positions; present the symbol reel outcome; determine a payline determination outcome for at least one payline determination indicator; present the payline determination outcome, and determine an award amount based on the multiple symbols in the multiple display positions corresponding to the payline determination outcome.

In some examples, the at least one processor may use the payline determination outcome to supplement a fixed payline game outcome corresponding to the symbol reel outcome. In a number of examples, the at least one processor may use the payline determination outcome to enhance a fixed payline game outcome corresponding to the symbol reel outcome. In various examples, the at least one processor may use the payline determination outcome to multiply a fixed payline game outcome corresponding to the symbol reel outcome. In some examples, the at least one processor may use the payline determination outcome to replace a fixed payline game outcome corresponding to the symbol reel outcome. In a number of examples, the at least one processor may present the symbol reel outcome by transmitting the symbol reel outcome to another device. In various examples, the at least one processor may present the payline determination outcome by transmitting the symbol reel outcome to another device.

In some implementations, a system may include at least one symbol reel operable to iterate through a sequence of possible symbol reel outcomes and stop at a final symbol reel outcome; at least one payline determination indicator operable to iterate through a sequence of possible payline determination outcomes and stop at a final payline determination outcome; and at least one processor. The at least one processor may determine a game outcome according to the final symbol reel outcome and the final payline determination outcome.

In various examples, the at least one payline determination indicator may be a physical reel. In some examples, the at least one payline determination indicator may be a virtual reel. In a number of examples, the at least one payline determination indicator may be displayed over the at least one symbol reel. In various examples, the at least one payline determination indicator may be positioned above or below the at least one symbol reel. In some examples, the at least one payline determination indicator may be positioned to a side of the at least one symbol reel. In various examples, the at least one payline determination indicator may be a light mechanism.

In a number of implementations, a system may include at least one non-transitory storage medium storing instructions; at least one symbol reel operable to iterate through a sequence of possible symbol reel outcomes; at least one payline determination indicator operable to iterate through a sequence of possible payline determination outcomes; and at least one processor. The at least one processor may execute the instructions to determine a symbol reel outcome; present the symbol reel outcome via the at least one symbol reel; determine a payline determination outcome; and present the payline determination outcome via the at least one payline determination indicator.

In various examples, the at least one processor may execute the instructions to present the symbol reel outcome prior to presenting the payline determination outcome. In some examples, the at least one processor may execute the instructions to present the symbol reel outcome after presenting the payline determination outcome. In a number of examples, the at least one processor may execute the instructions to present the symbol reel outcome while presenting the payline determination outcome. In various examples, the payline determination outcome may be determined in response to a bonus triggered in a fixed payline game. In some such examples, the bonus may correspond to a symbol presented via the at least one symbol reel.

In some implementations, a system may include at least one non-transitory storage medium storing instructions and at least one processor. The at least one processing unit may execute the instructions to determine a symbol reel outcome of multiple reels, each reel comprising multiple symbols and the symbol reel outcome comprising multiple symbols displayed at multiple display positions; present the symbol reel outcome; determine a payline modifier outcome; present the payline modifier outcome; and determine an award amount corresponding to the symbol reel outcome, at least one payline, and a relationship between the at least one payline and the payline modifier outcome.

In various examples, the at least one processor may determine the symbol reel outcome based on results of a bingo game. In a number of implementations of such examples, the at least one processor may determine the payline modifier outcome based on the results of the bingo game.

In some examples, the relationship between the at least one payline and the payline modifier outcome may include positions of the multiple display positions where symbols of the multiple symbols correspond to the payline modifier outcome and the at least one payline. In a number of examples, the at least one processor may determine the award amount corresponding to the symbol reel outcome and the at least one payline and then modifies the award amount based on the payline modifier outcome. In some such examples, the at least one processor may modify the award amount by multiplying the award amount.

As discussed above and as illustrated in the accompanying figures, the present disclosure relates to slot type games with dynamic paylines and/or dynamic payline modifiers. The slot type game includes a grid or matrix of symbols for which one or more symbol outcomes may be determined and presented. In embodiments with one or more dynamic paylines, the slot type game also includes at least one payline determination for which one or more payline outcomes may be determined and presented. The payline outcome may correspond to positions of symbols in the grid or matrix and may determine whether or not the corresponding symbols in the grid or matrix are winners. In embodiments with one or more dynamic payline modifiers, the slot type game also includes at least one payline modifier for which one or more payline modifier outcomes may be determined and presented. The payline modifier outcome may correspond to positions of symbols in one or more paylines and may determine whether or not the one or more paylines and/or symbols are modified. This may provide enhanced slot type game play over slot type games with fixed paylines.

In some examples, the dynamic payline and/or the payline modifier may determine whether the base slot type game is a winner or not. In other examples, the dynamic payline and/or the payline modifier may be initiated as a bonus game after the base slot type game completes, such as where the dynamic payline adds additional paylines to the payline used in the base slot type game, the dynamic payline enhances the payline used in the base slot type game, the payline modifier enhances the payline used in the base slot type game, and so on. In various examples, the payline determination and/or the payline modifier may be determined in tandem with the symbol outcome. In other examples, the payline determination and/or the payline modifier may be determined before and/or after the symbol outcome and may be used to enhance player anticipation as the payline determination is made. Presentation of the payline determination and/or the payline modifier may iterate through a number of possible payline outcomes before presenting the determined payline outcome, further enhancing player anticipation. The payline determination and/or the payline modifier may be presented using a variety of mechanisms, such as a separate physical and/or virtual reel that indicates the determined payline, indicator lights and/or other indicator elements (such as above, below, to the right, or to the left of rows or columns of the grid or matrix) that indicate rows or columns of the grid or matrix, graphical indicators presented over rows or columns of the grid or matrix that indicate rows or columns of the grid or matrix, and/or any other physical or virtual mechanism that may be used to present the payline determination. In some examples, the payline modifier may be presented using mechanisms used to indicate possible paylines, such as paylines that a player may select prior to playing a game, thus adding payline modifier capabilities to a slot type game without requiring additional hardware, software, and/or other components in order to present a payline modifier. In this way, the dynamic payline and/or the payline modifier may greatly expand the game capabilities of the slot type game without requiring additional rows or columns in the grid, additional symbols, and/or additional hardware and/or software resources beyond those used to determine and present the dynamic payline and/or the payline modifier. Such expanded game capabilities may greatly extend the useful life of the slot type game and/or greatly delay the time when the slot type game machine may be replaced.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system comprising:
at least one non-transitory storage medium storing instructions; and
at least one processor that executes the instructions to:
determine a symbol reel outcome of multiple reels, each reel comprising multiple symbols and the symbol reel outcome comprising the multiple symbols displayed at multiple display positions;
present the symbol reel outcome;
determine a payline determination outcome for at least one payline determination indicator;
present the payline determination outcome; and
determine an award amount based on the multiple symbols in the multiple display positions corresponding to the payline determination outcome.

2. The system of claim 1, wherein the at least one processor uses the payline determination outcome to supplement a fixed payline game outcome corresponding to the symbol reel outcome.

3. The system of claim 1, wherein the at least one processor uses the payline determination outcome to enhance a fixed payline game outcome corresponding to the symbol reel outcome.

4. The system of claim 1, wherein the at least one processor uses the payline determination outcome to multiply a fixed payline game outcome corresponding to the symbol reel outcome.

5. The system of claim 1, wherein the at least one processor uses the payline determination outcome to replace a fixed payline game outcome corresponding to the symbol reel outcome.

6. The system of claim 1, wherein the at least one processor presents the symbol reel outcome by transmitting the symbol reel outcome to another device.

7. The system of claim 1, wherein the at least one processor presents the payline determination outcome by transmitting the symbol reel outcome to another device.

8. A system comprising:
at least one symbol reel operable to iterate through a sequence of possible symbol reel outcomes and stop at a final symbol reel outcome;
at least one payline determination indicator operable to iterate through a sequence of possible payline determination outcomes and stop at a final payline determination outcome; and
at least one processor that determines a game outcome according to the final symbol reel outcome and the final payline determination outcome.

9. The system of claim 8, wherein the at least one payline determination indicator comprises a physical reel.

10. The system of claim 8, wherein the at least one payline determination indicator comprises a virtual reel.

11. The system of claim 8, wherein the at least one payline determination indicator is displayed over the at least one symbol reel.

12. The system of claim 8, wherein the at least one payline determination indicator is positioned above or below the at least one symbol reel.

13. The system of claim 8, wherein the at least one payline determination indicator is positioned to a side of the at least one symbol reel.

14. The system of claim 8, wherein the at least one payline determination indicator comprises a light mechanism.

15. A system comprising:
at least one non-transitory storage medium storing instructions; and
at least one processor that executes the instructions to:
determine a symbol reel outcome of multiple reels, each reel comprising multiple symbols and the symbol reel outcome comprising the multiple symbols displayed at multiple display positions;
present the symbol reel outcome;
determine a payline modifier outcome;
present the payline modifier outcome; and
determine an award amount corresponding to the symbol reel outcome, at least one payline, and a relationship between the at least one payline and the payline modifier outcome.

16. The system of claim 15, wherein the at least one processor determines the symbol reel outcome based on results of a bingo game.

17. The system of claim 16, wherein the at least one processor determines the payline modifier outcome based on the results of the bingo game.

18. The system of claim 15, wherein the relationship between the at least one payline and the payline modifier outcome comprises positions of the multiple display positions where symbols of the multiple symbols correspond to the payline modifier outcome and the at least one payline.

19. The system of claim 15, wherein the at least one processor determines the award amount corresponding to the symbol reel outcome and the at least one payline and then modifies the award amount based on the payline modifier outcome.

20. The system of claim 19, wherein the at least one processor modifies the award amount by multiplying the award amount.
